(19) United States
(12) Patent Application Publication
(10) Pub. No.: US 2009/0100702 A1
(43) Pub. Date: Apr. 23, 2009

(54) Apparatus and methods for improving the energy efficiency of dryer appliances

(76) Inventor: Robert Wood Fair, Tyler, TX (US)

Correspondence Address: Robert Wood Fair, 4828 S. Broadway #228, Tyler, TX, 75703, US

(21) Appl. No.: 12/284,279

(22) Filed: Sep. 19, 2008

Related U.S. Application Data
(60) Provisional application No. 60/994,575, filed on Sep. 20, 2007.

(51) Int. Cl. F26B 3/02; F26B 19/00; F26B 25/00; F26B 21/12

(52) U.S. Cl. 34/487; 34/218; 34/82; 34/86; 34/570

(57) ABSTRACT

Apparatus for improving the efficiency of dryer appliances that utilize heated air for drying and are disposed within a residence or other closed conditioned space includes an intake air duct connected between the dryer appliance and a source of intake air outside the conditioned space, an exhaust outlet diverter valve to receive exhaust air from the dryer and direct the exhaust air for release within the conditioned space or alternatively outside the conditioned space. Alternative embodiments provide for drawing intake air from more than one source, with and without heat exchange, for releasing heated air to more than one location, including into a heating system return air duct, either directly or through a heat exchanger. A method of controlling the operation of the apparatus is also provided.

### RELATED APPLICATION DATA

This application claims the benefits of U.S. Provisional Patent Application No. 60/994,575, filed Sep. 20, 2007.

### FIELD OF THE INVENTION

The present invention generally relates to apparatus and methods for substantially improving the efficiency with which thermal energy is utilized within a conditioned space, particularly but not limited to residential spaces, for the operation of appliances associated with that space; and in its most preferred embodiments relates to improving the thermal efficiency of clothes dryer appliance within or adjacent to a conditioned space with particular regard to sources of thermal energy, use of that energy in the appliance, and capture of previously under-utilized waste energy from the appliance for beneficial use within the conditioned space.

### BACKGROUND

Clothes dryer appliances operate by forcing warm air over and through the clothes to be dried so as to evaporate moisture from the clothes, and then exhausting the warm, moisture laden air from the dryer. Typically, intake air to be warmed and passed through the clothes is drawn from the space immediately surrounding the dryer, and the heated air carrying moisture from the clothes is exhausted outside the building. When the dryer is located within the conditioned space, intake air is typically drawn from within the conditioned space and exhaust air is released to the exterior of the building. The pressure differential created by exhausting the heated air results in drawing outside air into the building to replace the exhausted air. When the dryer is located outside the conditioned space, such as in a non-conditioned garage, porch, or the like, intake air to the dryer is not conditioned unless such intake air is drawn from the conditioned space itself.

In a building, such as a residence, when the interior air is conditioned by cooling to a temperature below that of the outside air or by heating to a temperature above that of the outside air, the use of conditioned interior air as intake air for a conventional dryer not only wastes the energy required to heat or cool that air, but also requires the expenditure of additional energy to condition the replacement air drawn into the building. Further, the heat energy remaining in the drying air that is exhausted to the exterior is similarly wasted. When the dryer is located outside the conditioned space, with intake air drawn from outside and exhaust air released outside, operation of the dryer does not directly affect the associated conditioned space, but in that circumstance all residual heat in the exhaust air, and the energy required to heat it, is wasted. Clothes dryers are among the most energy consumptive of all residential appliances, even without consideration of the energy required to condition replacement air, so reducing the total energy consumption associated with dryer operation, and utilizing waste heat from the dryer, can result in a significant reduction in total energy use by a household.

### SUMMARY OF THE INVENTION

The present invention provides a apparatus, in several embodiments, for recovering energy used for heating drying air, for eliminating the use of conditioned air for dryer intake air, and, generally, significantly improving the efficiency of the dryer and reducing the cost of operation. The invention also provides a method, also in several embodiments, of operating the dryer appliance and the apparatus of the invention so as to reduce overall energy consumption and improve energy efficiency.

The basic method of the invention comprises utilizing non-conditioned air as intake air for a clothes dryer, and, selectively exhausting heated air from the dryer into the conditioned space or to the exterior of the conditioned space. Eliminating the use of conditioned air as dryer intake air eliminates the infiltration of replacement air from the exterior of the building and thus the consumption of energy to maintain the desired temperature within the conditioned space. The use of non-conditioned exterior air as dryer intake air will reduce overall energy consumption regardless of whether interior air is conditioned by heating or by cooling, and is not dependent upon season or other climatic factors. Routing of exhaust air is, however, affected by whether building interior air is conditioned by heating or by cooling.

Under circumstances in which the air in the building is conditioned by heating, exhausting heated drying air into the interior of the building utilizes the energy consumed by the dryer for heating that air for heating the interior of the building, reducing the energy used by the primary heating system. Under circumstances in which the air in the interior air is conditioned by cooling, or whenever heating of the interior air is not desired, exhaust air from the dryer is routed to the exterior of the building. In one embodiment of the invention, the exhaust air is used to pre-heat dryer intake air by indirect heat exchange between the exhaust air stream and the intake air stream, reducing the energy required to heat the intake air to drying temperature in the dryer. Exhaust air may also be used as a heat source for, e.g. water heating and/or space heating.

The method of the invention is readily adaptable to use with existing, conventional dryers, and for incorporation into new dryers as an integral feature.

It is to be understood that all aspects and embodiments of the invention, as to both structure and method, are equally applicable to dryer appliances installed outside the “conditioned space” to which reference is made in the descriptions of the invention. Such an outside installation may be in a non-conditioned area such as a garage or porch, or may be in a space that is at least partially conditioned but outside the primary conditioned space. Minor structural variations to accommodate outside placement of the dryer appliance can be readily made within the scope of the invention.

The structure and features of the apparatus, and the method of the invention will be described in detail below, with reference to the accompanying drawing figures. The following description is presented in the general context of a dryer appliance located within the conditioned space referred to. The description is, however, equally applicable to an outside installation in the context of intake air source and exhaust air distribution, with intake air source location(s) and exhaust air release location(s) used to determine the mode of operation and mechanical component connections.

Further, in the following description is should be understood that reference to “conditioned” air does not necessarily refer to air in a physically enclosed building space, and does not necessarily mean that the temperature of conditioned air is artificially achieved or regulated.

### BRIEF DESCRIPTION OF THE DRAWINGS

FIG. 1 is a front elevation view of a dryer in place on an embodiment of the base unit.

FIG. 2 is a top view schematic illustration of a preferred embodiment of the invention for use with an existing dryer.

FIG. 3 is a schematic illustration of a basic structure and function of a diverter valve, shown with associated ducts.

FIG. 4 is a schematic illustration of an intake duct and two exhaust ducts with a diverter valve.

FIG. 5 is a schematic illustration of intake ducts with a diverter valve and exhaust ducts with a diverter valve.

FIG. 6 is a schematic illustration of intake ducts and exhaust ducts with individual control valves.

FIG. 7 is a schematic illustration of an embodiment of an automated control system.

FIG. 8 is a schematic illustration of a heat exchanger unit.

FIG. 9 is a schematic illustration of an automated shut-down system.

FIG. 10 is a schematic illustration of intake and exhaust air connections to a newly constructed dryer.

FIG. 11 is a schematic illustration of an embodiment of the invention with a control system for monitoring and maintaining a selected intake air temperature.

FIG. 12 is a schematic illustration of an embodiment of the invention with a first intake duct for drawing air from an attic space and with a second intake duct for drawing air from within the conditioned space of the building.

FIG. 13 is a schematic illustration of an embodiment of the invention with a first intake duct for drawing air from an attic space and with a second intake duct for drawing air from outside the attic space and outside the conditioned space.

FIG. 14 is a schematic illustration of an embodiment of the invention in which exhaust air is released directly into the conditioned space.

FIG. 15 is a schematic illustration of an embodiment of the invention in which exhaust air is used to heat air within the conditioned space by indirect heat exchange:

FIG. 16 is a schematic illustration of an embodiment of the invention in which exhaust air is released directly into the return air flow of a furnace system.

FIG. 17 is a schematic illustration of an embodiment of the invention in which exhaust air is used to heat return air to a furnace system by indirect heat exchange.

FIG. 18 is a schematic illustration of an embodiment of the invention in which intake air is heated by indirect heat exchange with combustion gases from a fuel fired appliance.

FIG. 19 is a schematic illustration of an embodiment of the invention in which intake air is heated by indirect heat exchange with exhaust air.

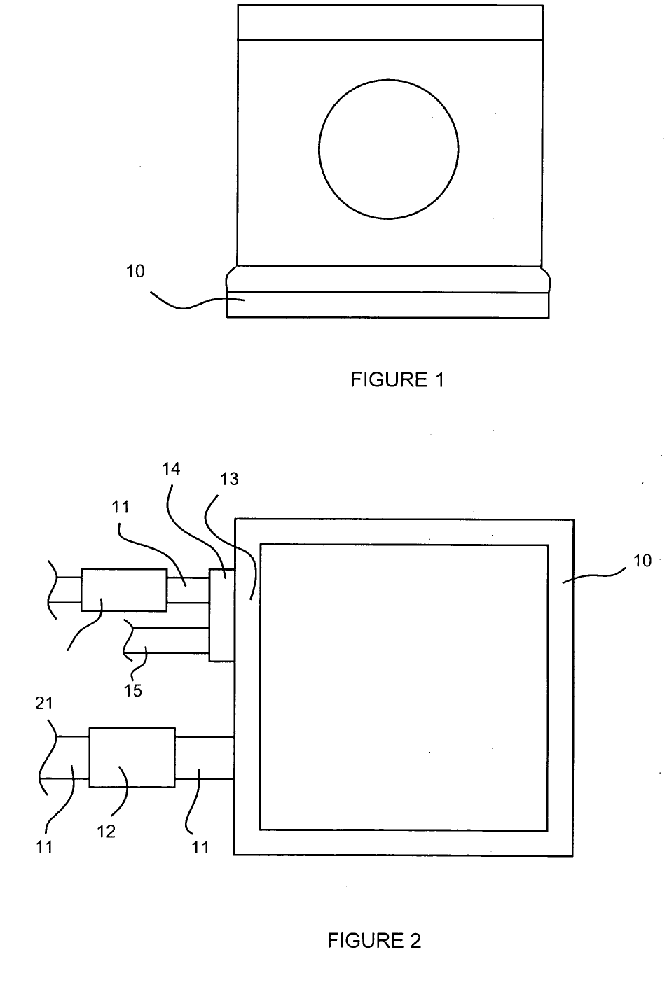

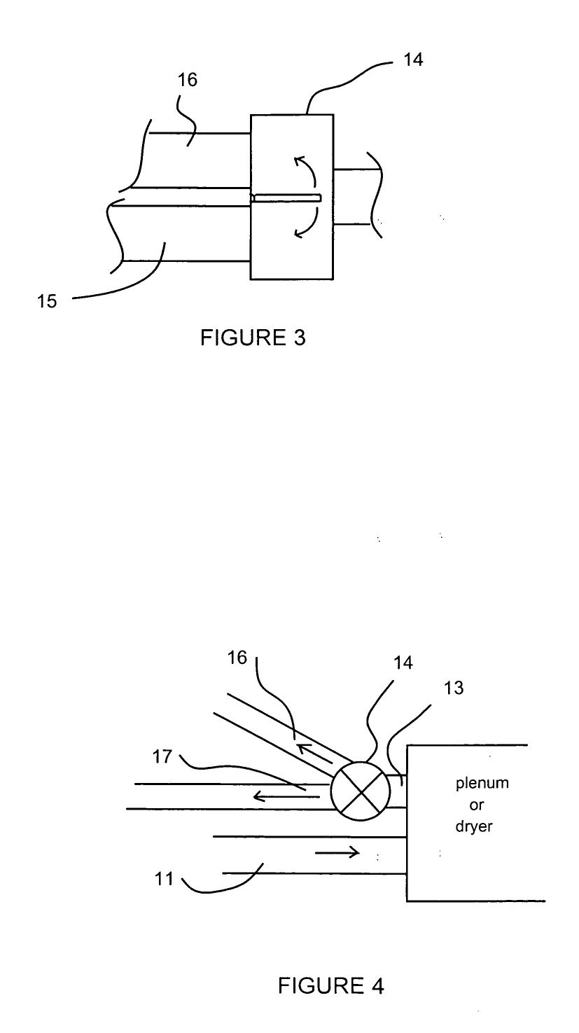

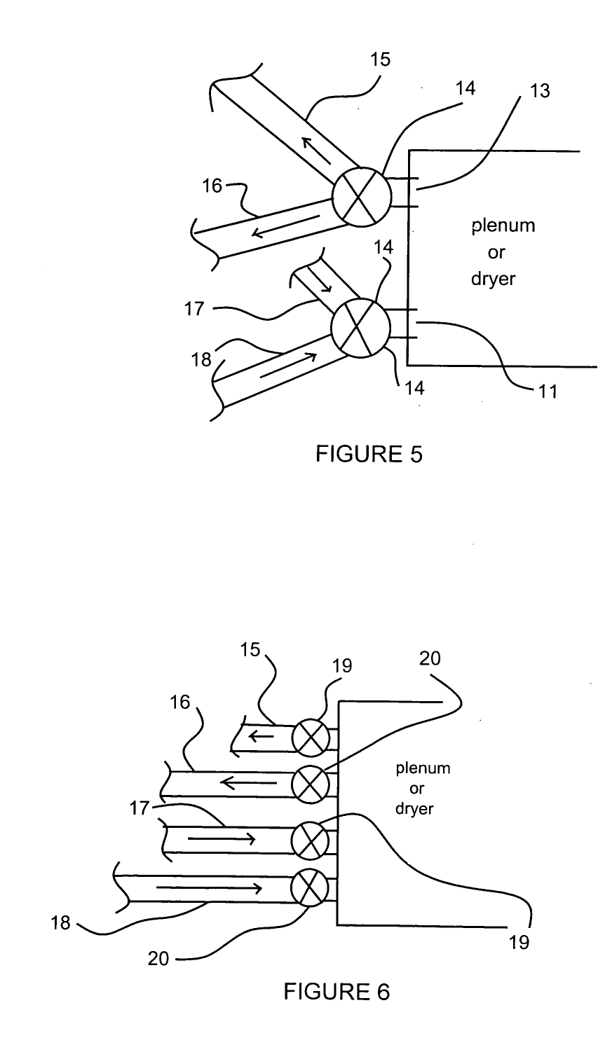

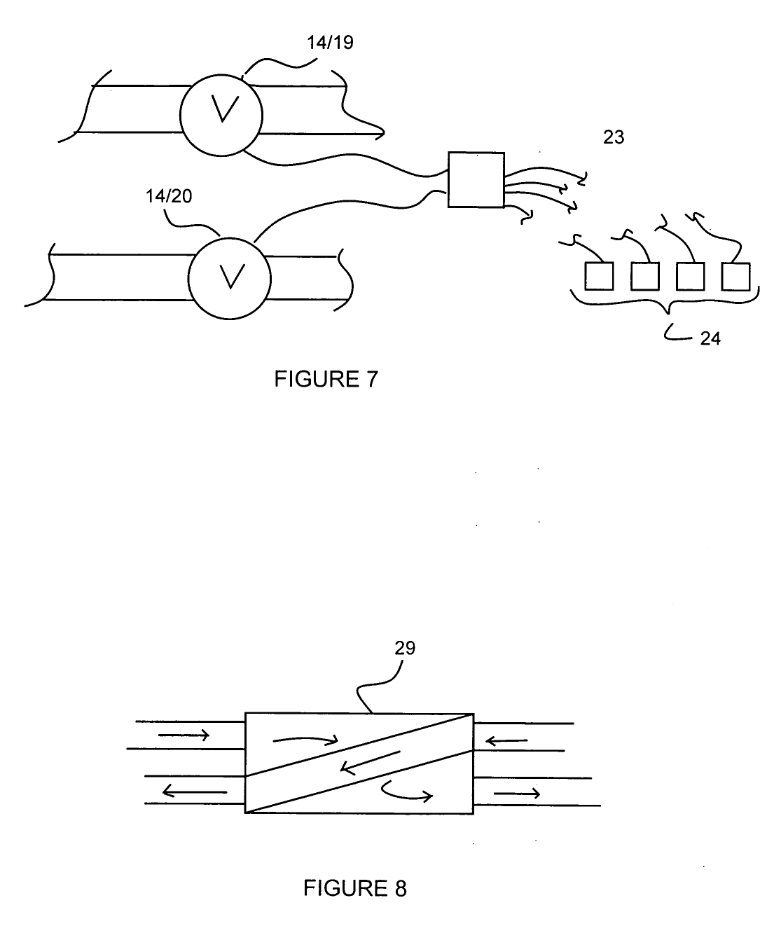

### DESCRIPTION OF THE INVENTION

In most conventional electrically heated dryers, the vast majority, if not the totality, of the intake air is drawn into the dryer at the base of the dryer cabinet, and in most conventional gas heated dryers the intake air is drawn into the dryer through the rear wall of the dryer cabinet. Referring now to the accompanying drawing figures, an embodiment of the apparatus of the invention for retrofitting a conventional electrically heated dryer for the use of exterior air as intake air includes a base plenum 10 to be disposed around the base of the dryer, with a generally air tight seal between the plenum and the sides of the dryer cabinet above the base, and above the intake point for a gas dryer, and with a generally air tight seal between the plenum and the floor or other surface upon which the dryer base rests. Any effective sealing means may be used within the scope of the invention, such as a rubber gasket or a bellows and tape. Alternatively, the base plenum may be structured to seal directly against the bottom edge of the dryer cabinet rather than sealing against the sides of the dryer cabinet. An intake air duct 11 extends from the plenum to the exterior of the conditioned space in which the dryer is positioned, to provide a passageway for the flow of exterior air to the plenum and into the dryer. For a dryer cabinet that is constructed with a closed bottom and has an air inlet aperture in one of the cabinet walls, base plenum 10 may be omitted and intake air duct connected directly to the existing air inlet aperture.

In another existing dryer retrofit embodiment, base plenum 10 may take the form of a flexible bag or sack with a flat, closed bottom and sides that extend partially up the side walls of the dryer cabinet from the bottom. Such a base may be slipped under a dryer without the necessity of lifting the entire dryer from the floor to allow the placement of the rigid base plenum described above, and does not result in the elevation of the dryer from its original position on the floor. The upper edge of the sack is sealed against the dryer cabinet sidewalls after it is positioned under the dryer. Air ducts for intake and exhaust air are provided in the side of the sack at the rear of the dryer.

For gas heated dryers, with an air intake disposed in the rear wall of the dryer, the use of a base plenum to control the flow of intake air and the source of that air may not be needed if all intake air is drawn through the dryer intake. If some of the air used by a gas heated dryer is drawn into the dryer through, e.g., the dryer base as with a typical electrically heated dryer, a base plenum can be used to allow control over the source of all incoming air.

It is preferred that the intake air drawn through duct 11 during operation of the dryer be routed through a filter unit 12 to remove particles such as dust, pollen, other airborne allergens and the like, as well as insects and other organisms, from the intake air. However, it is to be understood that although filtering the intake air is preferred, it is not an essential element of the invention, and filter unit 12 could be omitted if desired. It is preferred that duct 11 be routed so that the intake end of the duct is disposed in an attic space above the conditioned interior of the building, if the building includes an attic. The air in an attic space is typically warmer than the exterior air during much of the year, and it is preferred that intake air be drawn from the warmest available source to minimize the energy required for the dryer to increase the temperature of the intake air to drying temperature. In some instances the temperature of air drawn from an attic space may be sufficiently high that little or no additional heating of the intake air is required, further reducing energy use and costs. Drawing intake air from the attic also reduces the temperature in the attic space, since the air withdrawn from the attic is replaced by cooler outside air entering the attic through attic vents. Although it is preferred that intake air be drawn from an attic space or other space or source from which the air temperature is above that of the conditioned air inside the building, it is to be understood that the invention encompasses the use of any available source of intake air. As non-limiting examples, duct 11 may be routed through an outside wall, to a crawl space, or to a basement.

Air exhausted from the dryer is preferably routed from the existing exhaust outlet from the dryer cabinet through a relatively short first exhaust duct 13 to an exhaust air diverter valve 14. From diverter valve 14 the exhaust air is routed through either an exterior exhaust duct 15, in the conventional manner, or through an interior exhaust duct 16, depending upon the setting of the diverter valve. It is preferred that the diverter valve be marked with indicia such as “summer” or “exhaust to outside”, and “winter” or “exhaust to inside” to facilitate selection of the appropriate mode setting by the person operating the dryer. Selection of the “summer/exterior” mode setting of the diverter valve opens the exterior exhaust duct and closes the interior exhaust duct, so that exhaust air from the dryer is routed to the exterior of the building. Conversely, selection of the “winter/inside” mode setting results in routing the exhaust air from the dryer through the interior exhaust duct and into the interior of the building. A diverter valve 14 may also be placed in the inlet air duct, to allow inlet air to be drawn from two different sources, either separately or in combination, through initial inlet ducts 17 and 18, and air from the selected source(s) provided to the dryer through inlet duct 11. Such sources may include, but are not limited to, an attic space, a crawl space, and the exterior of the building. Various types of diverter valve devices and configurations are known in the prior art and readily available, and it is to be understood that any such valve suitable for controlling gas flows may be used within the scope of the invention.

Although the use of a two position diverter valve is preferred for controlling the outlet of exhaust air (and the source of intake air, when a diverter valve is positioned in the intake air duct), in order to assure that the flow path is not inadvertently blocked, two separate independently operated “on-off” valves 19 and 20 may be used, with a valve positioned in each of the exhaust air flow paths and/or intake flow paths. Although the use of two separate exhaust air control valves could result in blocking the exhaust air flow if both valves are placed in the “off” position, this arrangement provides an alternative approach to allowing a user to divide the exhaust air between the inside and outside of the structure. Similarly, the use of two valves to control the source of intake air would also provide an alternative means to allow a user to draw intake air from two locations. The ability to divide the air flow is also available with diverter valve(s) 14 by providing one or more intermediate settings for the diverter valve(s).

In a simplified installation, the air flow control valve or valves may be eliminated, so that intake air is always drawn from the same source and exhaust air is always directed to the same location. Although it sacrifices control over air flow, such a simplified installation may be appropriate and effective for particular climatic conditions. For example, in a cold climate where the conditioned space is heated year round, it may be desirable to always exhaust the dryer air into the building to provide heat to the space. Conversely in a hot climate, it may be desirable to always or almost always exhaust dryer air outside the building to avoid adding heat to the interior space.

Although dryers typically include a lint filter in the flow path of the exhaust air, a single lint filter is not fully effective in removing all lint and other particles from the exhaust air stream, and typically will not remove odors from the air. In order to remove lint and other solids from the dryer exhaust air before it is discharged into the building, it is preferred that a filter unit 21 be included in the flow path of the exhaust air before the release of the air into the building. Filter unit 21 may be disposed in any convenient location in the exhaust air path, whether externally or internally in the case of new dryer construction. Filter unit 21 includes one or more filter elements as need to remove solids from the exhaust air, and the filter element(s) are preferably removable for cleaning. Filter unit 21 also preferably includes a replaceable charcoal filter element, or other suitable element, for absorbing odors from the exhaust air before it is released into the building. The structure and configuration of filter unit 21 is subject to variation within the scope of the invention. The exhaust air may be released directly into the building space, or it may be released into the building's HVAC air flow path, for example.

When the dryer is operating in a mode in which the entirety of the exhaust air from the dryer is released into the interior of the building, intake air to the dryer may be drawn from the conditioned space within the building without loss of efficiency. Because all intake air drawn into the dryer is returned to the interior of the building, with no exhaust to the exterior, there is no infiltration of outside air. The use of interior air as intake air to the dryer can be particularly advantageous when the air available as dryer intake air from sources outside the conditioned space is at a less desirable temperature than the interior air.

In addition to embodiments for retrofitting the apparatus of the invention may to an existing, conventional dryer as described above, an apparatus of the invention may be readily integrated within the structure of a dryer during construction of the dryer. A newly manufactured dryer may include apparatus with a full complement of the features described herein, or with a more limited set of features. In that case it is preferred that provision be made for the future exchange or addition of elements to expand the scope of features. In the new manufacture embodiment, the dryer cabinet is provided with an intake air inlet 22, as illustrated in FIG. 10, for connection of an intake air duct 11, and the cabinet is otherwise sealed against the entry of intake air except through the air inlet. Plenum 10 is not required in this embodiment. The routing of duct 11 and the source of intake air is preferably as described above, and an intake air filter unit 12 is preferably provided.

As described above, exhaust air is routed through a diverter valve 14, or separate valves if used, and then through an exterior exhaust duct 15 or an interior exhaust duct 16, depending upon the setting of the valve or valves, also as described above. A filter unit 21, with solids filter elements and odor absorbing elements, is preferably disposed in the flow path of exhaust air through the interior exhaust duct prior to release from the dryer into the interior of the building. In this embodiment diverter valve 14, a portion of exterior exhaust duct 15, interior exhaust duct 16 and filter unit 21 may be disposed within the dryer cabinet for aesthetics and convenience. Regardless of the disposition of filter unit 21, it will be understood that the filter elements should be readily accessible for removal, cleaning, and replacement.

Diverter valve 14, or separate valves if used, may be operated manually, either directly or indirectly. For direct manual operation, the valve is provided with a hand operated lever or other mechanical means for selecting the position of the valve. Indirect manual operation may be effectuated by the use of, e.g., an electrically actuated solenoid that is activated to move the valve position between the two mode settings, with or without intermediate settings for mixing, by manual operation of an electrical switch. Movement of the valve, or valves, may also be actuated pneumatically or hydraulically in response to indirect manual activation.

Alternatively, selection of the mode of operation and the setting of the diverter valve or valves may be fully or partially automated so that operator selection is not required. In this embodiment an electronic control unit 23 is utilized to determine the appropriate mode setting, and actuate the diverter valve(s) accordingly, based upon information provided to the control unit. Information input to the control unit may be selected from a variety of input factors, as determined to be most effective for maximizing the efficiency of the system. Possible input factors may include, but are not limited to, exterior temperature, exterior humidity, interior temperature, interior humidity, air conditioning thermostat setting (heating versus cooling), desired interior temperature, and desired interior humidity. As in the indirect manual operation mode, movement of the valve, or valves, may be actuated electrically, pneumatically, or hydraulically. Information is provided to the control unit from sensors 24 disposed in appropriate locations and wired to the control unit. Wireless transfer of information may also be used. It is preferred that information to the control unit may also be input manually by an operator of the dryer, to override information received from associated sensor(s). Manual input to the control unit may also be utilized in lieu of some or all of the sensors referred to above.

A control unit 23 may provide a visually readable display of sensor readings or indicia as well as automatic control over dryer settings and operation, or the “control” functions of the unit may be omitted or eliminated so that it functions only as a display unit. Such an embodiment allows the operator of the appliance to make manual adjustments based on displayed sensor readings. When control unit 23 is provided with both control functions and displays the automatically selected settings along with sensor reading displays, the control unit may also allow the operator to override automatically selected settings, preferably with the limitation that the manually selected settings do not result in an operating condition that could be detrimental to dryer and/or the articles being dried.

The type or nature of sensors 24 is not critical to the invention, and it is to be understood that any effective sensor device or method may be used. It is also to be understood that an operator himself or herself may provide the same function as a separate sensor 24. Humans are able to distinguish relatively minor temperature differences, and that sense may provide sufficient information to an operator to allow him or her to select appropriate settings. Therefore, references to sensor information, sensor input, etc. may be taken as reference to an operator sensed parameter when appropriate to do so.

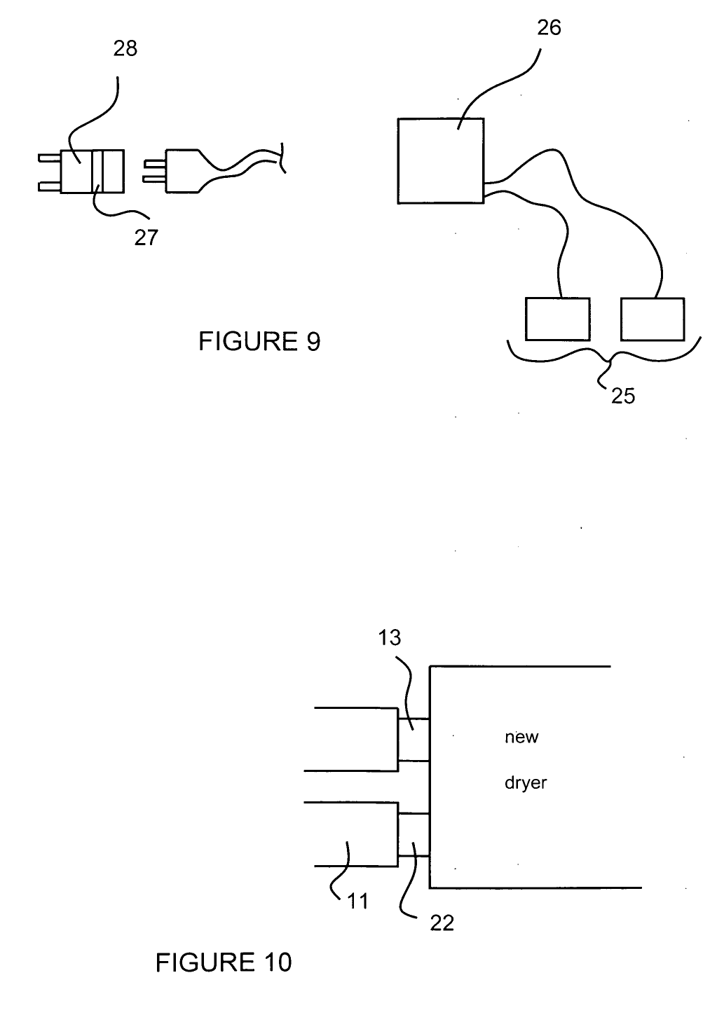

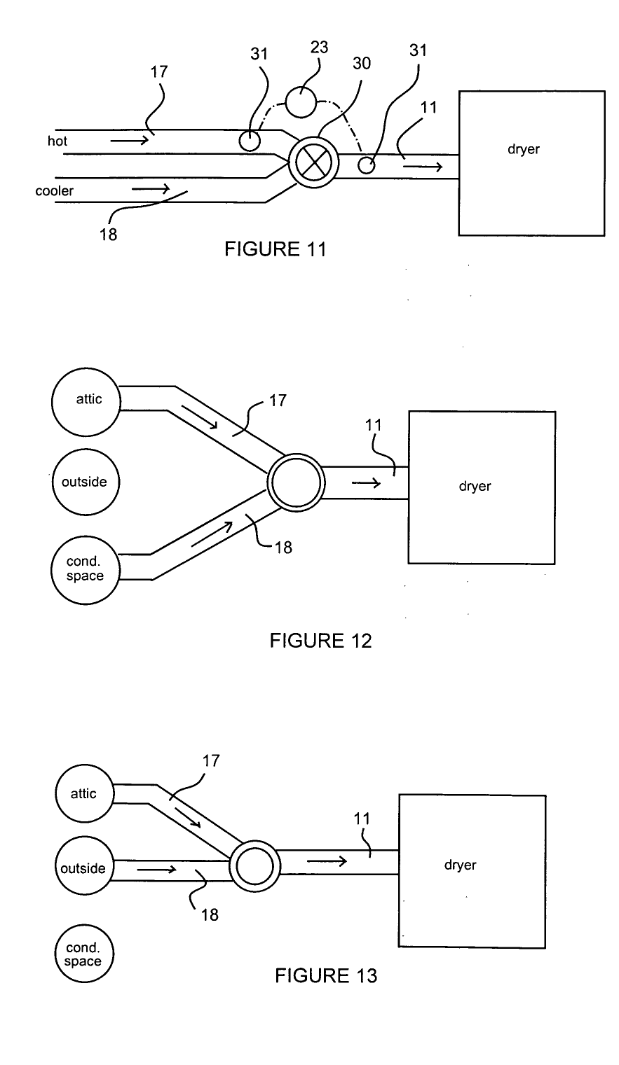

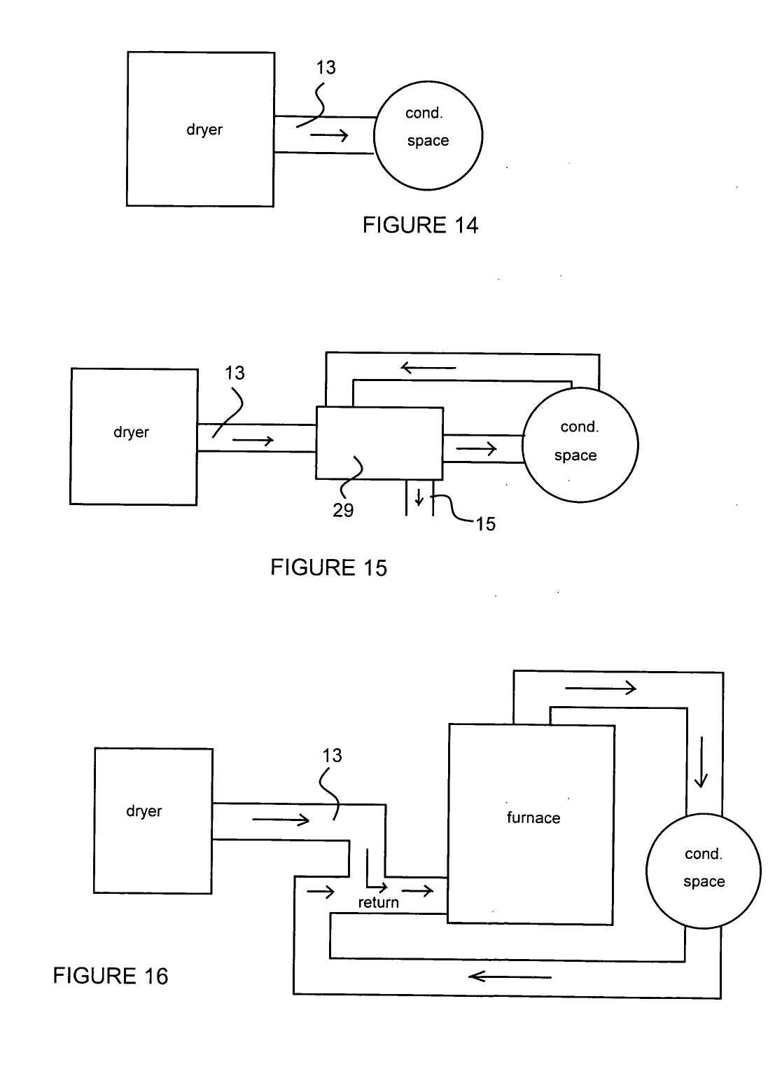

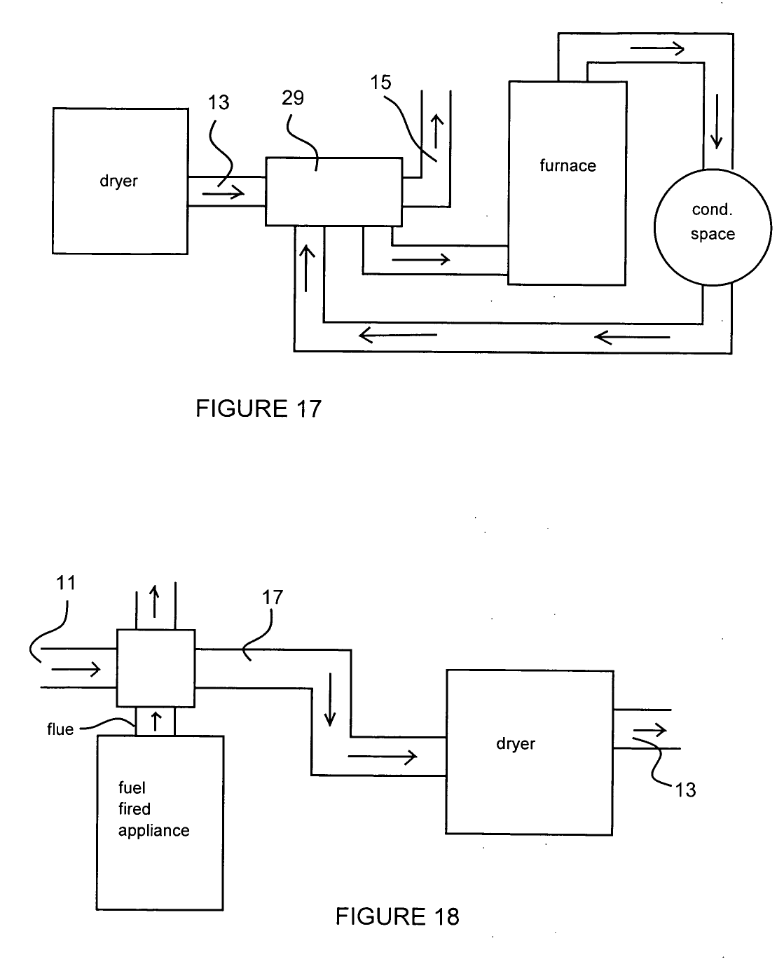

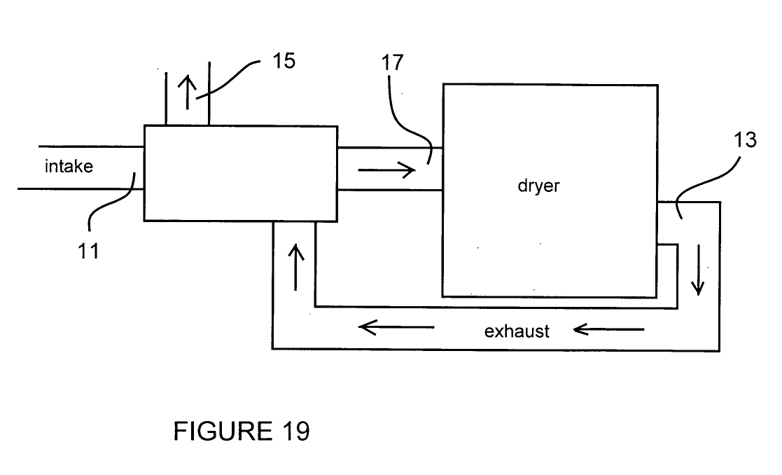

An automated control system may also be used to protect against damage to articles being dried as well as the dryer appliance itself in the event of a dryer unit malfunction. Pressure or flow rate shut-down sensors 25 may be disposed in exhaust duct(s), intake duct(s) or both, and information from the sensor(s) input to a shut-down control unit 26 that will automatically shut down the unit in the event the measured pressure or flow rate is outside a preselected range. For example, a blockage in either or both the operative intake duct and the operative exhaust duct will impede the flow of air through the dryer, which may result in overheating with consequent damage to clothing in the dryer and/or to the dryer itself. Overheating may also create a safety hazard. With an automated control system, if measured pressure or air flow parameters fall outside the selected range the control unit will activate a shut-down switch 27 to interrupt electrical power to the dryer. The shut-down switch may be disposed within the dryer itself, particularly when the control system in incorporated into the structure of a new dryer, or in a separate unit 28, schematically illustrated in FIG. 9, that plugs between the wall receptacle and the dryer power cord, and is connected to the control unit. Regardless of its location, the shut-down switch is provided with a reset means, preferably manually operated, to restore the electrical connection to the dryer when the problem causing the shut-down has been resolved. It is preferred that the automated control system provide an audible and/or visual indication that a shut-down has occurred, and, preferably, also an indication of the nature of the problem that caused the shut-down to occur.

In a variation of the damage prevention control system described immediately above, the shut-down control unit 26 may be eliminated as a separate component, and the sensor(s) 25 connected directly to shut-down switch 28. In this variation a sensor 25 is selected that will send a signal when a particular parameter value is read or a threshold value is exceeded, rather than a steady data signal, and shut-down switch 28 will automatically open upon receipt of the sensor signal. A single sensor may be used, or a plurality of sensors may be employed to read a variety of parameters and send a signal to shut-down switch 28 when triggered, to effectuate a shut-down if any of a variety of undesirable operating conditions is detected.

In an alternative, or expanded version of the damage prevention control system, the control unit may be designed to respond to a sensor 25 indicating a blockage in one of initial intake ducts 17 or 18 by automatically changing the position of the intake diverter valve to draw intake air through the non-blocked duct. If the sensor communicates to the control unit that the air flow rate or pressure is still below the pre-selected shut-down value, the control unit will then shut off power to the dryer to prevent damage. This same control approach can also be used to switch between exterior and interior exhaust if the reduced flow or pressure is measured in an exhaust duct, but it should be kept in mind that it may be more desirable to shut down the dryer than to exhaust heated air into a building within which the air is conditioned by cooling.

As an alternative to the damage control system based upon flow rate and/or pressure as described above, a control system based upon dryer exhaust temperature includes a temperature sensor disposed in the exhaust duct to provide temperature information to a shut-down control unit, or directly to a shut-down switch as described above. In this alternative system, shut-down switch 27 will be activated, either by a control unit or by direct input from the sensor in the event the exhaust outlet temperature is either above or below selected values, so as to assure that the dryer will operate within an effective and safe temperature range selected by the operator or manufacturer.

As noted above, intake air may be preheated by indirect heat exchange with heated exhaust air from the dryer. In this embodiment the intake air and the exhaust air are routed through a heat exchange unit 29, preferably in counter-current flow, for the transfer of heat energy from the heated exhaust air to the relatively cooler intake air. The heat exchange unit may be disposed in any convenient location outside the dryer cabinet, or within the cabinet or a base plenum. Increasing the temperature of the intake air reduces the amount of heat necessary to raise the temperature of the intake air to drying temperature, and correspondingly reduces the energy consumed for generating such heat. A heat exchange unit 29 may also be used to pre-heat intake air by indirect heat exchange with, e.g., combustion gases from any fuel fired appliance (such as, without limitation, a gas-fired clothes dryer, water heater or furnace). Much of the heating value of the fuel used to fire such appliances is lost up the flue, so any heat capture from the flue gases will improve the efficiency of the building's heat generating systems. When the appliance is located in an attic space, or the flue pipe runs through an attic, attic air can be further pre-heated by passing the attic air through a heat exchanger 29 to be further heated by the combustion gases. It can be expected that in some circumstances the intake air will have reached a sufficiently high temperature to preclude the need for additional heating in the dryer unit itself. With a dryer appliance in which the activation of the dryer heating unit is controlled by a switch means, a sensor 24 may be placed in the intake air stream and connected to the control unit, which is in connection with the dryer heat switch means. In the event that the intake air temperature is within a pre-selected temperature range input to the control unit, the control unit will prevent activation of the dryer heating unit. However, it is also contemplated that in some circumstances the temperature of air from a hot attic will exceed the proper drying temperature of the dryer. When such a possibility is anticipated or encountered, it is preferred that a mixing valve 30 be used to mix cooler air with the high temperature air before it is introduced to the dryer for operation. The mixing valve 30 and sensors 31 are preferably located relatively near the dryer intake, so that the incoming hot air temperature and the air temperature after mixing can be monitored and the volume of hot and cool air passing through the mixing valve adjusted. It is preferred that the temperature monitoring and the positioning of the mixing valve be controlled by the automatic electronic control unit 23, but it is to be understood that the mixing valve can also be controlled manually, based upon operator sensed or displayed temperature parameters, within the scope of the invention. It will be understood in the context of the mixing valve that a diverter valve 14 with intermediate settings is capable of functioning as a mixing valve, and is encompassed within the more general designation of a mixing valve 30.

It is to be understood that releasing dryer exhaust air into the interior of a building is safe when dryer heat is provided by electricity (i.e., without combustion), but it may be neither safe nor permissible when dryer heat is provided by combustion and the combustion gases are combined with the exhaust air from the drying process and exhausted through the same duct. Accordingly, it will be understood that references in the foregoing description to direct release of exhaust air into a building are applicable to a situation in which the dryer exhaust air does not contain unsafe levels of combustion gases. When the dryer exhaust does include unsafe levels of combustion gases, heat energy in the dryer exhaust can be transferred to the interior of the building by indirect heat exchange. When heat is captured from combustion gases, care should be exercised to assure that the post-exchange gases retain enough heat to maintain a safe flow of gases up the flue or chimney.

Air or other fluids used to cool compressed refrigerant in an air conditioning condensing unit may also be used as a source of heat for dryer intake air and/or for other purposes. Warmed air passing from the condenser coils could be used directly for dryer intake air, or dryer intake air could be heated by indirect heat exchange with water or other heat exchange fluid used to cool the coils. It is to be understood that heat from an intermittently operated appliance, such as a water heater, furnace, or condenser unit, will be available to heat incoming dryer air only when the appliance is operating. Accordingly, the benefit that can be derived from utilizing such heat sources will be increased when an automatic control system is used. In such a circumstance the control unit 23 may be connected to the intermittently operated appliance(s) so as to provide a signal to the control unit when the other appliance is operating. The control unit may be programmed to activate the dryer appliance only when the other appliance is operating, or to delay initial activation of the dryer appliance until the other appliance initiates a heat producing operation. The control unit 23 may also be used to activate and deactivate the dryer heating unit so as to maintain the intake air temperature within a pre-selected range as the other heat producing appliances activate and deactivate during their normal operations. The control system of the invention provides sufficient flexibility in its functions, determined by programming input to the control unit, for it to be used to control a wide variety of dryer appliance functions, and potentially the functions of other appliances with which the dryer appliance operation is coordinated. Although the use of an automated control system is preferred, it is to be understood that a manually monitored and activated control system may also be used within the scope of the invention.

A heat exchange unit 29 may be used to transfer heat from the exhaust air to air within the building without directly exhausting the heated air from the dryer into the building. The placement of heat exchange unit 29 is not critical, and the unit, if used, may be disposed in any convenient location. After passing through the heat exchange unit, the cooled exhaust air from the dryer can then be routed to the exterior of the building, either directly or after a secondary heat exchange with intake air, if the temperature of the exhaust air is above that of the incoming intake air. In this embodiment filter unit 21 could be omitted entirely, or a simplified filter unit without means for odor removal could be used, since the exhaust air stream from the dryer is not released directly into the building. However, filtering of air used for heat exchange is preferred, to avoid a loss of effectiveness due to build-up of lint on heat exchange surfaces. The heat exchange unit may be disposed in any desired and accessible location, such as in the building's HVAC system air flow path, or may be disposed in closer proximity to or within the dryer unit. Heat scavenged from exhaust air in the heat exchange unit may be released into the interior air where the dryer is located or at any other desired location within the building. A fan or blower may be included in the heat exchange unit to assist in circulation of the warmed air as well as increasing the heat exchange efficiency.

An air to water heat exchange may also be used to transfer heat from the dryer exhaust air to water or to another heat transfer fluid for a variety of uses such as, but not limited to, domestic water heating and/or non-refrigerant heat pump working fluid. Even though the heat available from dryer exhaust air may not raise water temperature to a high enough level for the intended use, pre-heating water with exhaust air will reduce the energy required to further raise the temperature to the desired level, and will improve overall efficiency.

The energy efficiency of a dryer can also be increased by insulating the dryer cabinet, and the addition of insulation to both existing dryers and new dryers is preferred in the context of the invention. External insulation can be easily added to an existing dryer, and internal insulation can easily be incorporated into the structure of new dryers. It is preferred that ducts or duct sections from which heat loss is undesirable also be insulated.

The foregoing description of the invention is intended to be illustrative of the full scope of the invention, which is not limited to the embodiments and variations described but encompasses additional embodiments and variations that may be devised based upon the written specification, the drawings, and the following claims.

1. An apparatus for improving the energy efficiency of a dryer appliance that utilizes heat and air in the drying process, the dryer being associated with a building containing air that has been conditioned to an interior temperature different from the temperature of the air outside the conditioned space, the dryer appliance having a cabinet with a passageway for intake air and an exhaust outlet for conveying heated drying air from the dryer cabinet, the apparatus comprising,
an intake duct with a hollow interior for the passage of air, therethrough, said duct having an open first end and an open second end, said first end disposed outside the conditioned space so as to allow the entry of air drawn from outside the conditioned space into said intake duct, and said second end connected in air flow communication with the dryer appliance passageway for intake air;
an exhaust diverter valve assembly having one incoming exhaust air conduit connected to the exhaust outlet of the dryer appliance such that air exhausted from the dryer appliance passes through said incoming exhaust air conduit of said exhaust diverter valve assembly, having two outlet air conduits to selectively carry exhaust air from said exhaust diverter valve assembly to different destinations, having an exhaust diverter valve means for controlling the proportion of incoming air from said incoming exhaust air conduit that exhausts outwardly through each of said outlet air conduits between zero percent of said incoming exhaust air to one hundred percent of said incoming exhaust air flow, and having an adjustment means for adjusting said exhaust diverter valve means so as to control said proportion;
a first exhaust duct having an open first end and an open second end, said first end of said first exhaust duct connected to the first of said two outlet air conduits in air flow communication therewith, and said second end of said first exhaust duct disposed outside the conditioned space of the building for the release of dryer exhaust air diverted through said first exhaust duct to the exterior of the conditioned space; and
a second exhaust duct having an open first end and an open second end, said first end of said second exhaust duct connected to the second of said two outlet air conduits in air flow communication therewith, and said second end of said second exhaust duct disposed within the conditioned space of the building such that residual heat energy in the outlet air from the dryer may be recovered and utilized so as to improve the efficiency of energy use.

2. The apparatus of claim 1, wherein the dryer appliance cabinet has a base, wherein the passageway for intake air is through the base of the cabinet, and wherein the apparatus further comprises a plenum means, configured and dimensioned to fit between the base of the dryer cabinet and an underlying surface, with said plenum means disposed on said underlying surface in generally air tight relation therewith, and with the dryer cabinet disposed on and sealed against said plenum means in generally air tight relation, such that the passageway for intake air into the dryer is within said plenum means, with said second end of said intake air duct connected to said plenum means.

3. The apparatus of claim 2, wherein said plenum means comprises a generally rigid base plenum disposed between the base of the dryer cabinet and the underlying surface in generally air tight relation, with the base of the dryer disposed on said base plenum in generally air tight relation therewith, and wherein said second end of said intake duct is connected to said base plenum.

4. The apparatus of claim 2, wherein said plenum means comprises a flexible bag plenum configured and dimensioned to extend fully under the base of the dryer and extend upwardly therefrom, with said bag plenum sealed against the dryer in generally air tight relation, and wherein said second end of said intake duct is connected to said bag plenum.

5. The apparatus of claim 1, further comprising a filter unit disposed between said air flow diverter valve assembly and said second exhaust duct.

6. The apparatus of claim 1, further comprising a filter unit disposed between said exhaust air outlet from the dryer appliance and said incoming exhaust air conduit of said diverter valve assembly.

7. The apparatus of claim 5, wherein said filter unit includes a removable filter media for removing solid particles from the dryer exhaust air.

8. The apparatus of claim 5, wherein said filter unit includes a removable filter media for absorbing odors from the dryer exhaust air.

9. The apparatus of claim 1, wherein said intake air duct is a first intake air duct, and wherein the apparatus further comprises,
an intake air diverter valve assembly having two incoming air conduits, one outgoing air conduit connected in air flow communication with the passageway for intake air into the dryer, an incoming air diverter valve means for controlling the proportion of air from the first of said incoming air conduits and the proportion of air from the second of said incoming air conduits that flows through said outgoing air conduit between zero percent of the outgoing air flow and one hundred percent of the outgoing air flow, and having an incoming air adjustment means for adjusting said intake diverter valve means so as to control said proportion, with said first intake air duct connected at said second end thereof to said first of said incoming air conduits; and
a second intake air duct having a hollow interior, an open first end and an open second end, said first end disposed in a different location from said first end of said first intake air duct, and said second end connected at said second end to the second of said intake air conduits of said intake air diverter valve assembly.

10. The apparatus of claim 1, wherein said adjustment means of said exhaust diverter valve assembly comprising a manually activated handle connected to said exhaust diverter valve means.

11. The apparatus of claim 9, wherein said adjustment means of said exhaust diverter valve assembly comprises a manually activated exhaust valve handle, and wherein said adjustment means of said incoming air diverter valve means comprises a manually activated incoming air valve handle.

12. The apparatus of claim 9, wherein said adjustment means of said exhaust diverter valve assembly comprises an electrically activated solenoid operatively connected to said exhaust diverter valve means, and wherein said adjustment means of said incoming air diverter valve means comprises a second electrically activated solenoid operatively connected to said incoming diverter valve means.

13. The apparatus of claim 9, wherein the building with which the dryer is associated has an attic space outside the conditioned space within the building, wherein said first end of said first intake air duct is disposed in the attic space, and wherein said first end of said second intake air duct is disposed in the conditioned interior of the building.

14. The apparatus of claim 9, wherein the building with which the dryer is associated has an attic space outside the conditioned space, wherein said first end of said first intake air duct is disposed in the attic space, and wherein said first end of said second intake air duct is disposed outside both the attic and the conditioned space.

15. The apparatus of claim 1, wherein dryer exhaust air flowing from said second end of said second exhaust duct is released directly into the conditioned space so as to utilize residual dryer heat for directly heating the conditioned space.

16. The apparatus of claim 1, further comprising a heat exchanger assembly connected to said second end of said second exhaust duct, a third hollow exhaust duct with open first and second ends, connected at said first end to said heat exchanger assembly and with said second end of said third exhaust duct disposed for the release of dryer exhaust air outside the conditioned space, said heat exchanger providing a passageway for the flow of conditioned air from the conditioned space through said heat exchanger assembly to return to the conditioned space, so as to indirectly utilize residual dryer heat for heating air within the conditioned space without releasing dryer exhaust air directly into the conditioned space.

17. The apparatus of claim 1, wherein the building is provided with a furnace system for conditioning air within the building by heating, wherein the furnace system includes an air duct assembly for the passage of air drawn from the conditioned space, through the furnace, and released into the conditioned space, and wherein dryer exhaust air flowing from said second end of said second exhaust duct is released directly into the air duct assembly of the furnace system for distribution and release into the conditioned space.

18. The apparatus of claim 16, wherein the building is provided with a furnace system for conditioning air within the building by heating, wherein the furnace system includes an air duct assembly for the passage of air drawn from the conditioned space through the furnace and back to the conditioned space, wherein said heat exchanger assembly has an outlet duct, and wherein said outlet duct of said heat exchanger assembly is connected to the air duct loop of the furnace system of so as to direct heated air from said heat exchanger assembly into said air duct assembly for distribution into the conditioned space.

19. The apparatus of claim 1, wherein the building is provided with a fuel fired heating appliance with a flue extending from the heating appliance through a space outside the conditioned space of the building for carrying and exhausting hot combustion gases from the heating appliance, and wherein the apparatus further includes a heat exchanger assembly disposed in said intake duct and connected to the heating appliance flue in heat transfer relationship therewith and with dryer intake air drawn through said intake duct, so as to transfer heat from the heating appliance combustion gases to dryer intake air in said heat exchanger assembly when the heating appliance is operating.

20. The apparatus of claim 1, wherein the building includes a water heating appliance to which make-up water is provided through a water line, and wherein the apparatus further includes a heat exchanger assembly disposed and connected in the flow path of dryer exhaust air such that said heat exchanger assembly provides a passageway for the flow of dryer exhaust air therethrough, said heat exchanger assembly further connected in the flow path of make-up water to the water heating appliance in heat exchange contact with said dryer exhaust, so as to pre-heat the make-up water by indirect heat exchange with dryer exhaust air when the dryer appliance is operating and generating heated exhaust air.

21. A control system for controlling the operation of a dryer appliance associated with a building having a conditioned space, the dryer appliance including an intake air passageway for supplying intake air to the dryer appliance, the dryer appliance including an exhaust outlet for conveying heated exhaust air from the dryer appliance, an exhaust diverter valve assembly with one inlet connected to the dryer exhaust outlet, two outlets for conveying exhaust air from the diverter valve assembly, and a moveable valve element for selecting the proportion of dryer exhaust air directed through each of the two outlets from the diverter valve assembly between zero percent and one hundred percent of the dryer exhaust air, comprising,
A control unit for receiving information from at least one sensor device and generating output for controlling the movement of the moveable valve element so as to determine the flow of dryer exhaust air through each of the two outlets of the diverter valve assembly;
a sensor device operatively connected to said control unit to provide information signal input to said control unit from said sensor; and
an actuator means for moving the moveable valve element in order to control the proportional flow of dryer exhaust air through the two outlets of the diverter valve assembly in response to information from said control unit.

22. The control system of claim 21, wherein said sensor device is a temperature sensor disposed within the conditioned space of the building, wherein said control unit is provided with a pre-selected temperature value, and wherein the signal output from said control unit to said activation device is determined within the control unit by comparing the temperature read by said sensor device and the pre-selected temperature provided to said control unit.

23. The control system of claim 21, wherein the dryer appliance includes a first intake air duct connected at one end in air flow communication with the dryer appliance and with the opposite end disposed in a first source of intake air, and further includes a second intake duct connected at one end in air flow communication with the dryer appliance with the opposite end disposed in a second source of intake air different from the first source, wherein the dryer appliance includes an intake diverter valve assembly with two inlets, with the first and second intake air ducts connected to respective ones of the intake diverter valve inlets, one outlet connected in air flow communication with the dryer appliance, and a moveable valve element for selecting the proportion of dryer intake air drawn from each of the two intake ducts providing air to the second diverter valve assembly between zero percent and one hundred percent of the air intake air required for operation of the dryer appliance, and wherein the control system further comprises,
a further plurality of said sensor devices, each of said sensor devices selected from a group of sensor device types including temperature sensors, humidity sensors, and pressure sensors, each of said sensor devices disposed in a location selected from the group of locations including the location of the first source of intake air, the location of the second source of intake air, and a location within the conditioned space; and
a second activation device disposed in operative connection with the moveable valve element of the intake diverter valve assembly, and connected to said control unit so as to receive signal output generated by said control unit in response to information input from said sensors, so as to move the moveable valve element of the intake diverter valve assembly in order to control the proportional flow of intake air from the intake ducts through the diverter valve assembly to the dryer appliance.

24. The control system of claim 23, wherein said control unit receives information from said sensor devices, processes said information, and generates output for controlling the movement of the moveable valve element of the intake diverter valve assembly so as to determine the source of intake air, as well as controlling the movement of the moveable valve element of the exhaust diverter valve assembly so as to determine the flow of dryer exhaust air through each of the outlets from the exhaust diverter valve assembly.

25. A protective control system for a dryer appliance that is dependent upon a supply of electrical power for operation, the dryer appliance having an intake duct for conveying drying air to the dryer appliance and an exhaust duct for conveying air exhausted from the dryer appliance, comprising,
a shut-down switch operatively connected between the supply of electrical power and the dryer appliance, said shut-down switch configured to open and interrupt the supply of electrical power to the dryer appliance upon receipt of a control signal;
and
a sensor device operatively connected to said shut-down switch, said sensor device selected and disposed to read information regarding the selected dryer appliance operating parameter, and to generate a signal.

26. The protective control system of claim 25, wherein said sensor device is a pressure sensor, wherein said sensor is disposed in the exhaust duct from the dryer appliance, and wherein said sensor device is set to generate a signal in the event the air pressure measured by said sensor device is above a pre-selected value.

27. The protective control system of claim 25, wherein said sensor device is a temperature sensor, wherein said sensor is disposed in the exhaust duct from the dryer appliance, and wherein said sensor device is set to generate a signal in the event the air temperature measured by said sensor device is above a pre-selected value.

28. The protective control system of claim 25, wherein said sensor device is a temperature sensor, wherein said sensor is disposed in the exhaust duct from the dryer appliance, and wherein said sensor device is set to generate a signal in the event the air temperature measured by said sensor device is below a pre-set value.

29. The protective control system of claim 25, wherein said sensor device is an air flow rate sensor, wherein said sensor is disposed in the exhaust duct from the dryer appliance, and wherein said sensor device is set to generate a signal in the event the air flow measured by said sensor device is below a pre-selected value.

30. The protective control system of claim 25, wherein said sensor device is an air flow rate sensor, wherein said sensor is disposed in the intake duct to the dryer appliance, and wherein said sensor device is set to generate a signal in the event the air flow measured by said sensor device is below a pre-selected value.

31. A method of controlling the operation of a dryer appliance to improve operating efficiency and reduce operating costs, the dryer appliance associated with a building structure and a conditioned space, the dryer appliance having an intake duct connected at one end to the dryer appliance for conveying dry air to the dryer appliance, with the opposite, intake end of the intake duct disposed outside the conditioned space in a source of air, the dryer appliance having an exhaust diverter valve with an exhaust air inlet connected to the dryer appliance and with two exhaust air outlets selectable by operation of the exhaust diverter valve, an exterior exhaust duct connected at one end to one of the two exhaust air outlets with the opposite end disposed outside the conditioned space so as to release exhaust air directed through the exterior exhaust duct outside the conditioned space, an interior exhaust duct connected at one end to the other of the two outlets with the opposite end disposed within the conditioned space, so as to release exhaust air directed through the interior exhaust duct within the conditioned space, and a means of actuating the exhaust diverter valve to direct exhaust air flow through a selected one of the exhaust ducts, comprising the steps of,
sensing the ambient temperature of air outside the conditioned space;
comparing the sensed temperature of the outside air to a pre-set temperature value to determine whether the sensed air temperature is above or below said pre-selected temperature value;
if the sensed air temperature is above said pre-selected temperature value, actuating the exhaust diverter valve to direct exhaust air from the dryer appliance into and through the exterior exhaust duct and release said exhaust air outside the conditioned space; and
if the sensed air temperature is below said pre-selected temperature value, actuating the exhaust diverter valve to direct exhaust air from the dryer appliance into and through the interior exhaust duct and release said exhaust air within the conditioned space.

32. The method of claim 31, wherein the sensed temperature is the temperature of air within the conditioned space of the building.

33. The method of claim 32, wherein the dryer appliance further has an intake diverter valve with one outlet connected to the dryer appliance intake for supplying drying air, with two inlets, and with a means for actuating the intake diverter valve so as select the flow path through the diverter valve between the outlet and either of the two inlets, the intake duct being a first intake duct, connected to one of the two inlets, wherein the dryer appliance has a second intake duct connected at one end to the other of the inlets of the intake diverter valve with the opposite, intake end of the second intake duct disposed outside the conditioned space in a location different from the location of the first intake duct, and wherein the control system includes two additional temperature sensors, comprising the additional preliminary steps of,
sensing the ambient temperature of air outside the conditioned space at the location of the intake end of the first intake duct;
sensing the ambient temperature of air outside the conditioned space at the location of the intake end of the second intake duct;
comparing the temperature at the intake end of the first intake duct to the temperature at the intake end of the second air duct to determine which of the temperatures is higher; and
actuating the intake diverter valve so as to draw intake air for operation of the dryer appliance from the location having the higher of the sensed air temperatures.

34. The method of claim 31, wherein the dryer appliance has a heating unit for heating intake air used for drying, wherein the heating unit is activated and deactivated by a switch, and wherein the control system further includes an inlet temperature sensor to read the temperature of air entering the inlet end of the inlet duct, an internal dryer temperature sensor, and a display unit for displaying the temperatures read by the sensors, comprising the additional steps of,
positioning the internal dryer temperature sensor so as to read the operating temperature of drying air within the dryer appliance;
conveying the temperature information read by the internal dryer temperature sensor to the display unit;
comparing the temperature read by the internal dryer temperature sensor to a pre-selected internal dryer appliance temperature to determine whether the temperature read by the internal dryer temperature sensor is above or below said pre-selected internal dryer temperature;
if the temperature read by the internal dryer temperature sensor is above said pre-selected internal dryer temperature, activating the heating unit switch to turn the heating unit off; and
if the temperature read by the internal dryer temperature sensor is below said pre-selected internal dryer temperature, activating the heating unit switch to turn on the heating unit on.

35. The method of claim 34, wherein the operation of the dryer appliance is controlled by an on-off switch, comprising the additional steps of,
after a pre-selected time interval, again comparing within the control unit the temperature read by the internal dryer temperature sensor to the pre-selected internal dryer temperature; and
if the internal dryer temperature remains above the pre-selected internal dryer temperature after the pre-selected time interval, activating the dryer appliance on-off switch to turn the heating unit off.

36. The method of claim 31, wherein the operation of the dryer appliance is controlled by an on-off switch, wherein the source of intake air where the intake end portion of the intake duct is disposed is subject to heating and cooling cycles, and wherein the dryer appliance includes a control system with an intake air temperature sensor, and a control unit for monitoring information input from the temperature sensor, processing information input, and generating activation signals to actuator means, comprising the additional steps of
positioning the intake air temperature sensor so as to read the temperature of the source of intake air to the intake duct;
conveying the temperature information read by the air intake temperature sensor to the control unit;
comparing the temperature read by the intake air temperature sensor to a pre-selected initiating temperature value; and
if the intake air temperature read by the intake air temperature sensor is above the pre-selected initiating temperature for the dryer appliance, actuating the on-off switch so as to turn on the dryer appliance and initiate dryer appliance operation.

37. The apparatus of claim 9, wherein said adjustment means of said exhaust diverter valve assembly comprises a hydraulic activator operatively connected to said exhaust diverter valve means, and wherein said adjustment means of said incoming air diverter valve means comprises a second hydraulic activator operatively connected to said incoming diverter valve means.

38. The apparatus of claim 9, wherein said adjustment means of said exhaust diverter valve assembly comprises a pneumatic activator operatively connected to said exhaust diverter valve means, and wherein said adjustment means of said incoming air diverter valve means comprises a second pneumatic activator operatively connected to said incoming diverter valve means.

39. The control system of claim 21, wherein said control unit is a display unit, wherein said actuator means is an operator of the dryer appliance, and wherein said information from said control unit is in the form of a human readable visual display.

40. The protective control system of claim 25, further comprising a control unit for receiving signals from said sensor, processing said signals, and generating a control signal, said control unit being operatively connected between said sensor and said

41. The method of claim 31, wherein the dryer appliance further includes a control system having a temperature sensor, a control unit for monitoring information input from the temperature sensor, processing information input, and generating activation signals to actuator means, wherein said step of sensing air temperature is performed by the sensor unit, the comparison of temperatures is performed with the control unit, and the actuation of the diverter valve is activated by the control unit.

42. The method of claim 34, wherein the display unit is also a control unit for processing information and generating control signal output based upon such processing, wherein the step of comparing temperatures is performed by the control unit, and wherein the steps involving activating the heating unit switch are performed by the control unit.
